(19) United States
(12) Patent Application Publication
(10) Pub. No.: US 2012/0070252 A1
(43) Pub. Date: Mar. 22, 2012

(54) METHOD AND DEVICE FOR SUPPLYING GLASS MELTING FURNACES WITH FREE FLOWING GLASS MIXTURES

(75) Inventor: Erich Waltert, Erlenbach (DE)

(73) Assignee: BETEILIGUNGEN SORG GMBH & CO. KG, Lohr am Main (DE)

(21) Appl. No.: 13/322,221

(22) PCT Filed: Feb. 19, 2010
(86) PCT No.: PCT/EP2010/001041

§ 371 Date: Nov. 23, 2011

(30) Foreign Application Priority Data
May 26, 2009 (DE) 10 2009 022 696.6

(51) Int. Cl. B65G 25/08

(52) U.S. Cl. 414/166; 414/804

(57) ABSTRACT

A method and a device for supplying free flowing glass mixtures by transport devices for feeding the glass mixture through a doghouse opening of a glass melting furnace above the glass level, and a pusher driven by a pusher arm for distributing the glass mixture on the glass melt. The transport devices and the pusher arm extend through the doghouse opening and at are least extensively sealed. To feed glass mixture into the furnace and to distribute it over the melt surface in a targeted manner, thereby extensively maintaining the sealing of the interior of the furnace from the surroundings, the glass mixture is applied to the glass melt by two adjacent transport devices and independently controlled with regard to the delivered quantity per unit of time, and is distributed over the glass melt by continuous rotary motions of the pusher at both sides of the pusher arm.

The present invention relates to a method for supplying glass melting furnaces having at least one doghouse with free-flowing glass mixtures, by means of

a) transport devices for introducing the glass mixture through a doghouse opening above the glass level, and

b) by means of a pusher, driven periodically by a pusher arm, for distributing the glass mixture on the glass melt,

c) the transport devices and the pusher arm being guided through the doghouse opening so as to be at least extensively sealed.

From U.S. Pat. No. 4,854,959 and the corresponding DE 37 09 178 C2 and EP 0 282 939 A3, it is known, in devices for charging glass melting furnaces, to combine a channel-shaped charging device (also called a “chute” in the specialist literature) for supplying glass forming agents with a pusher (as it is referred to in the specialist literature) for distributing portions of the glass forming agents on the melt surface. Both are introduced into the furnace chamber through a heat shield formed by the atmosphere. While the charging device is moved in the longitudinal direction so as to vibrate with a relatively high frequency, the pusher is driven with a very much lower frequency by separate drives for horizontal and vertical movements that produce rectangular movement transitions. The channel of the charging device has a rectangular cross-section having a floor that is flat but is inclined downward in the direction toward the furnace, so that it is not possible to deliberately distribute the flow of supplied material on the melt surface in different directions and quantities. In addition, it is difficult to seal the furnace chamber against the entrance of ambient air and against the exit of combustion gases and heat radiation, which are both effects that disturb or impair both the operation of the furnace and the environment. The movement of the supplied material on the melt surface is also determined by the stroke direction of the pusher and is thus limited. Moreover, such a device is expensive and requires high maintenance, and has not found wide acceptance in practice.

Through prior public use by applicant, it is also known to situate a wedge-shaped projection immediately before the lower edge of the channel or chute, which projection divides the mixture flow of supplied material. However, in this way it is also not possible to modify the mixture flows on both sides of the projection in a specific manner and independently of one another; rather, distribution patterns in the cross-section of the channel, once present, are fixed in this way.

DE 83 04 858 U1 discloses an insert device for a glass melting furnace made up of a combination of a supply channel having a rectangular internal cross-section as a transport path for supplied material and a pusher, there designated a mixture spreading device. The conveyor channel is connected to a vibrating drive, and the pusher is connected to a crank drive that produces a movement sequence having the shape of a flat ellipsoid. Through construction on a pivot device as known from crane design, this combination can execute a wide-ranging pivot movement in order to distribute the supplied material on the glass melt also in the lateral direction. For a partial sealing of the furnace chamber, a heat shield is provided that, due to the large opening necessary for the pivot movement, is made in the furnace wall as a sector of a hollow cylinder jacket that, in its center position, extends well past the opening at both sides. In order to guide through the above combination with its tolerances and degrees of freedom, the heat shield has an opening that, seen in a top view, has a cross-section in the shape of an inverted T. This cross-section occupies approximately ¼ to ⅓ of the cross-section of the opening in the adjacent furnace wall. In addition, there is also an annular gap between the lower edge of the heat shield and the lower edge of the opening in the furnace wall. As a result, the sealing effect is limited. This prior art also has no means for setting different mixture flow quantities within the width of the overall mixture flow of supplied material.

From GB 1 364 187 A, at the charging end of a glass melting furnace that does not have a doghouse it is known to situate two threaded conveyors for glass raw materials oriented at an angle of 90° to one another. This is intended to achieve a technique known as batch swing technique. A pusher for presetting a transport device for the glass raw materials and for subdividing these materials into portions that float on the melt surface is not provided. Rather, conveyor devices are to be compelled on which there are superposed different magnitudes of conveyed quantities per time unit, and that are oriented in alternating fashion toward the one or the other side wall of the melt tank. Here, the reversal of the conveyed quantities takes place as a function of local temperature measurements of the melt, and the overall conveyed quantity is additionally controlled as a function of the position of the melt level. Such control methods are however extremely time-dependent due to the inertia of the temperature changes, and are therefore imprecise. In particular, however, the interior chamber of the furnace above the melt is not sealed against the charging area. In addition, the conveying devices are each situated under separate silos, so that the constructive outlay is increased, and refillings are required twice as often.

U.S. Pat. No. 2,509,390 A is based on the object of covering the surface of a glass melt over the entire width of the tank as uniformly as possible with a sealed layer of charging material. As a consequence, this device first of all lacks a pusher for subdivision into portions and the directed transport of these portions on the melt surface. The dominant components of the transport directions run parallel to the longitudinal axis of the melt tank. Underneath four transport containers that can be moved linearly, there are situated two intermediate storage units, each pivotable about a vertical axis, having slot-shaped floor openings that are provided with controllable sealing plates for the purpose of dosage. The pivot movements are intended to give determinate directions to two large-surface flows of material on the melt. These multi-axis movements require a large number of actuating elements that also have to be correspondingly monitored. Independently of this, however, the charging apparatus has a quite enormous constructive height and a width corresponding to the width of the melt tank, and as a result is completely unsuitable for charging a melt tank via a doghouse.

The object of the present invention is to indicate a method and a device with which it is possible to introduce the charging material for glass melting furnaces into the furnace with the lowest possible expense for manufacture, operation, and maintenance, and to distribute said material therein on the melt surface in a well-directed manner, while keeping the interior space of the furnace extensively sealed against the environment.

According to the present invention, this object is achieved in the method indicated above in that

d) the glass mixtures are supplied to the transport devices from a common supply container via a distributor chamber,

e) the glass mixtures are applied onto the glass melt using two transport devices situated next to one another and that are controllable independently of one another with regard to the conveyed quantity per time unit, and

f) the glass mixtures are distributed and displaced on the glass melt through continuous rotational movements of the pusher on both sides of the pusher arm.

The present invention creates a method and a device with which it is possible to introduce into the furnace the charging material for glass melting furnaces with the lowest possible outlay for manufacture, operation, and maintenance of the device, and to distribute said material on the melt surface in the furnace in a well-directed manner, and to bring said material onto travel paths on said surface that correspond to the flow of the glass melt. Thus, for example it is possible to use the present invention for cross-fired furnaces and for end-fired furnaces, and to situate both the end wall and the side walls over the furnace tank, while also keeping the interior chamber of the furnace extensively sealed against the environment. This sealing is effective against both the penetration of ambient air, which disturbs the furnace atmosphere, and also against the exiting of combustion gases and heat radiation that pollute the surroundings and the environment.

In further embodiments of the method, it is particularly advantageous if, either individually or in combination,

by means of the transport devices, portions of glass mixture are deposited on the glass melt that are separated from one another in pairs,

the inner cross-sections of the transport devices are kept at least extensively sealed against the interior chamber of the doghouse,

transport devices are used that, as screw conveyors, are realized with helical coils and tubular housings, situated in pairs and at least extensively sealed in a sealing plate of the doghouse opening,

the shafts of the transport devices are each oriented at an acute angle to the direction of advance of the pusher,

the transport directions of the rows of portions of the glass mixture on the glass melt are modifiable by modifying the angular positions of the pusher relative to its direction of advance, and/or

the transport directions of the portions of the glass mixture on the glass melt are modifiable by modifying the angular positions of partial surfaces of the pusher relative to its direction of advance.

The present invention also relates to a device for charging glass melting furnaces that have a doghouse with free-flowing glass mixtures,

a) having transport devices for introducing the glass mixture through a doghouse opening of the glass melting furnace above the glass level, and

b) having a pusher that is driven periodically via a pusher arm for distributing the glass mixture on the glass level,

c) the transport devices and the pusher arm being led through the doghouse opening of the glass melting furnace so as to be at least extensively sealed.

In order to achieve the same object and the same advantages, according to the present invention such a device is characterized in that

d) the transport devices are connected via a distributor chamber to a common supply container for the glass mixture,

e) for the glass mixture, two transport devices are situated next to one another in the doghouse that can be controlled independently of one another with regard to the conveyed quantities per time unit, and

f) the transport devices are situated on both sides of a vertical virtual midplane in which the pusher arm of the pusher is movable.

In further embodiments of the device, it is particularly advantageous if, either individually or in combination,

by means of the transport devices, portions of glass mixture can be deposited on the glass level that are separated from one another in pairs,

the inner cross-sections of the transport devices are at least extensively sealed against the interior chamber of the doghouse,

the transport devices, as screw conveyors, are fashioned with helical coils and tubular housings, situated in pairs and at least extensively sealed in a sealing plate of the doghouse opening,

mounted before the sealing plate is a heat protection shield whose circumference can be laid against the outer edge of the doghouse opening,

the axes of the transport devices are each oriented at an acute angle to a virtual vertical midplane,

the angular position of the pusher relative to its pusher arm is made so as to be modifiable,

the pusher has partial surfaces having different angular positions relative to its pusher arm,

the transport devices, the sealing plate, and the heat protection shield are fastened to a device frame that is movable in the direction toward the doghouse in a manner such that the heat protection shield at least extensively seals the doghouse opening,

the device frame has two horizontal frames that are connected to one another at their corners by vertical supports,

in the space between the supports there is situated a platform to which the pusher arm is connected and that is connected by a rigidly attached arm to an eccentric drive from which the pusher receives its circumferential path,

the other side of the platform is supported on the device frame via vertically spaced intermediate joints having horizontal axes, in such a manner that movements of the platform having horizontal components can be compensated,

on the device frame, over a distributor chamber there is situated a supply hopper for the glass mixture having two limbs that are connected to the transport devices via funnel-shaped intermediate pieces, and/or

in the sealing plate there is situated a pass-through opening for the pusher arm, and the pass-through opening has an elastomeric insert having a vertical slot in which the pusher arm is guided so as to be sealed.

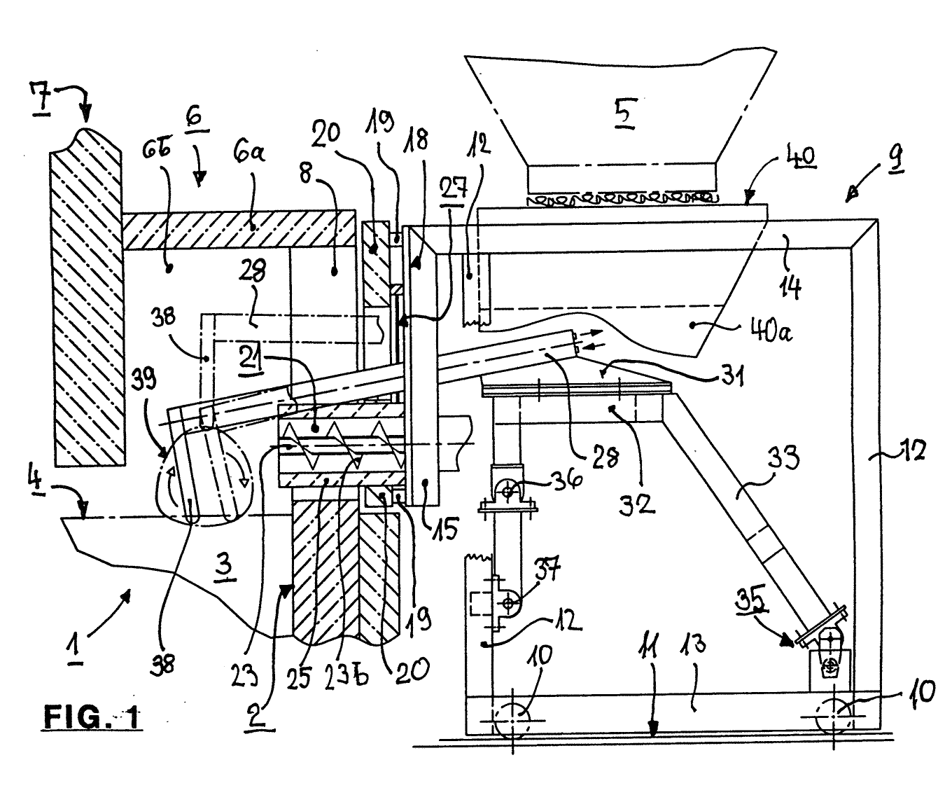

An exemplary embodiment of the subject matter of the present invention and its manner of functioning, and additional advantages, is explained in more detail below on the basis of FIGS. 1 through 5.

FIG. 1 shows a vertical section through a furnace wall, through a device frame having parts of the charging device, and through one of the transport devices for the glass mixture,

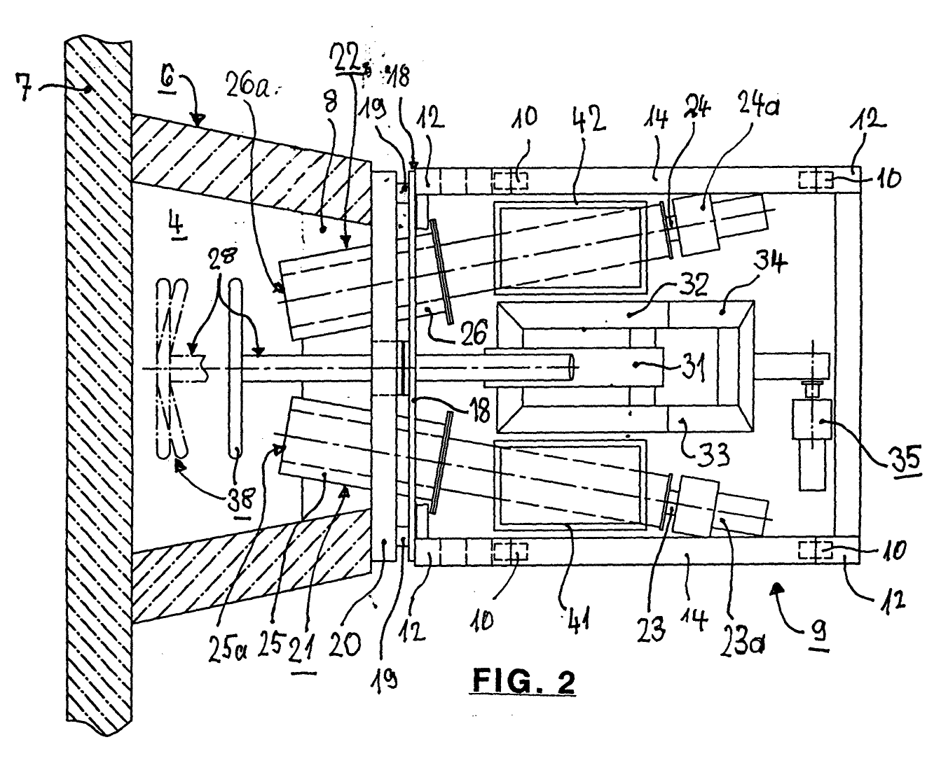

FIG. 2 shows a top view of the parts of the charging device as shown in FIG. 1 in the vertical direction,

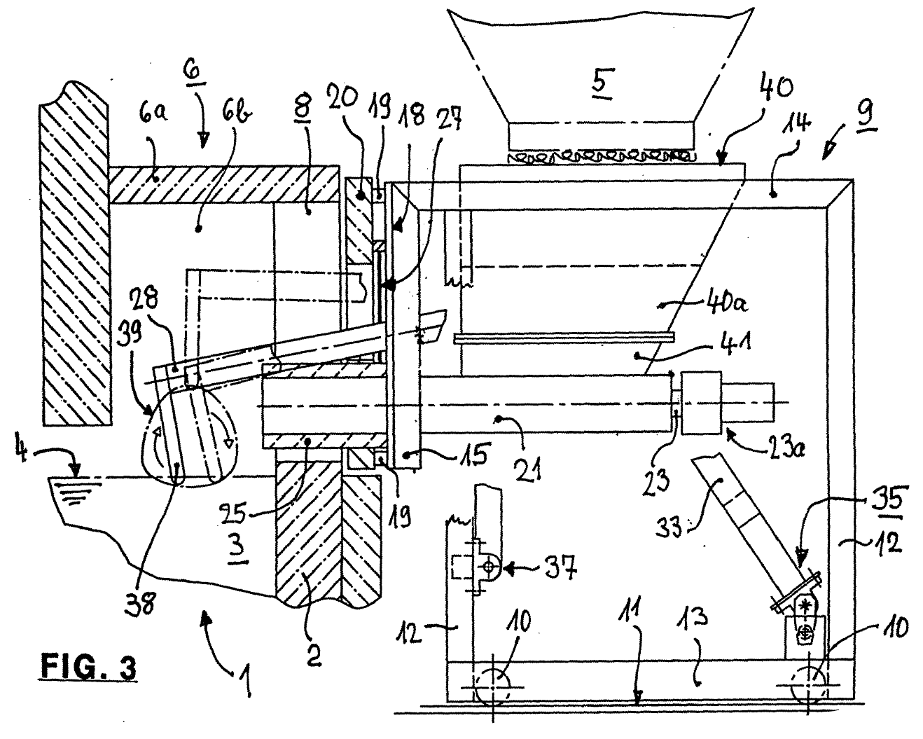

FIG. 3 shows an inner view of the drive elements for the pusher in the horizontal direction,

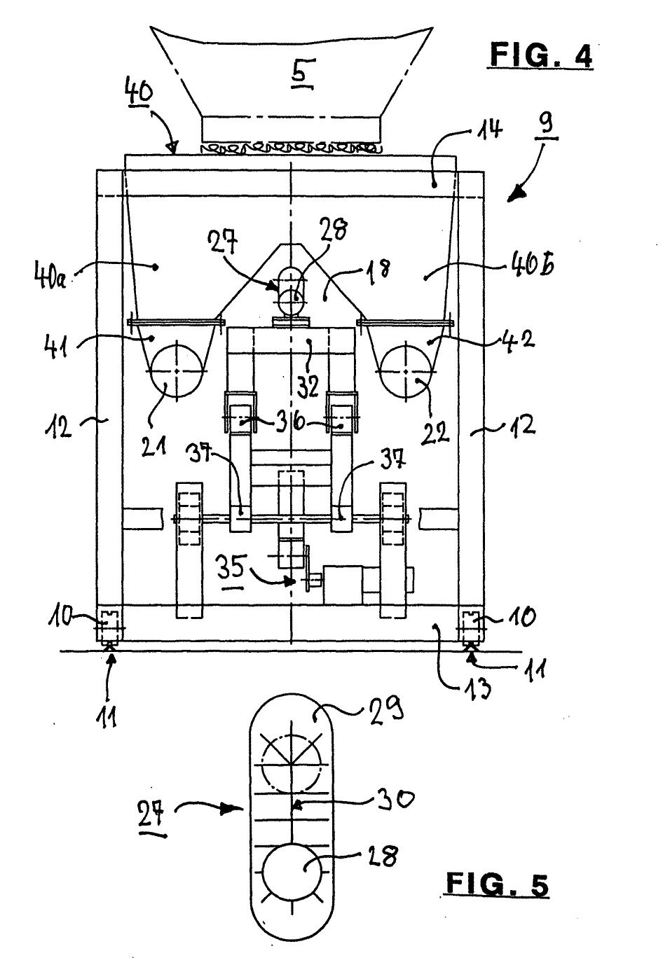

FIG. 4 shows a rearward view of the charging device, in the direction toward the furnace, and

FIG. 5 shows a top view of the pass-through opening shown in FIG. 4 in an enlarged scale.

FIGS. 1 and 2 show a partial section of a glass melting furnace 1 having a melt tank 2 containing a glass melt 3 having a glass level 4. Above this glass level 4 there is situated a so-called “doghouse” 6 for the supply of the glass mixture, intermediately stored in a supply hopper 5. Doghouse 6 has a doghouse cover 6a, two doghouse side walls 6b, and a doghouse opening 8, all of which are situated in front of a furnace wall 7.

Next to this doghouse opening 8 there is situated a device frame 9 that can be moved on rails 11 by means of wheels 10 and that has four supports 12 situated at the vertical edges of an imaginary cuboid. These supports are connected at the upper and lower ends by horizontal frames 13 and 14, as is also seen in FIGS. 2 through 4. Upper frame 14 has on the furnace side a U-shaped arm 15 to which is fastened a stable sealing plate 18 made of metal and, via spacer mounts 19, a heat protection shield 20. Two transport devices 21 and 22 are guided through sealing plate 18 in gas-tight fashion, these transport devices here being realized as screw conveyors and each having a shaft 23 and 24 having geared motors 23a and 24a. The helical coils 23b and 24b of shafts 23 and 24 are surrounded, with a small amount of play, by a respective cylindrical housing 25 and 26 fastened in gas-tight fashion in sealing plate 18 and having an opening 25a and 26a for the exit of the glass mixture over glass level 4. In this way, together with the glass mixture radiation-tight and at least extensively gas-tight locks are formed between the interior space of doghouse 6 and the atmosphere. For cooling, housings 25 and 26 can be provided with hollow spaces and water connections (not shown).

Heat protection shield 20 is held on sealing plate 18 by spacer mounts 19, and a pass-through opening 27 for pusher arm 28 is situated in heat protection shield 20. This pass-through opening 27 has a flexible insert 29 having a vertical slot 30 in its center (see also FIG. 5). Heat protection shield 20 can be moved up to the edges of doghouse opening 8. In this way, and due to the good seal of pusher arm 28 in insert 29, the exiting of radiation, dust, and gases from doghouse 6, and the entry of air from the surrounding environment into doghouse 6, are drastically limited.

Shafts 23 and 24 are driven with controllable rotational speeds by a respective geared motor 23a and 24a, so that independent conveyed quantities per time unit, which can each be between 0 and 100% of the total conveyed quantity, can be deposited onto glass level 4.

Regarded together, FIGS. 1, 2, and 4 show details of the drive of pusher arm 28. This arm is connected, via an intermediate piece 31 inside device frame 9, to a frame-type platform 32 connected rigidly at opposite sides to arms 33 and 34. Via a controllable motoric eccentric drive 35, platform 32 is pivoted and displaced parallel to the plane of the drawing, and intermediate joints 36 and 37 enable horizontal movement components. At the opposite end, pusher arm 28 is provided inside doghouse 6 with a pusher 38 whose lower edge is periodically immersed in glass melt 3 during forward movement, and is lifted out again for rearward movement, here being guided on a closed circumferential path 39 in the direction of the arrow, this direction being determined by eccentric drive 35 and the design of the intermediate elements. In this way, the flows of material ejected from or exiting from transport devices 21 and 22 on glass level 4 are divided into portions and displaced on this level. Pusher arm 28 and pusher 38 are cooled by water, as indicated in FIG. 1 by the two arrows.

As indicated by broken lines in FIG. 2, pusher 38 can also be fastened completely or partly at various angles on pusher arm 28. In this way, it is possible to impart a preferred direction to the initial direction of the portions of the glass mixture inside doghouse 6, which in turn makes it possible to connect the relevant device to doghouses 6 situated at different points on the circumference of melt tank 2.

A combined view of FIGS. 3 and 4 also shows the manner in which the glass mixture is supplied to the charging device and distributed therein. Supply hopper 5 is situated centrically above device frame 9 and opens into a distributor chamber 40 having two vertical limbs 40a and 40b, to which transport devices 21 and 22 are connected via funnel-shaped intermediate pieces 41 and 42.

### LIST OF REFERENCE CHARACTERS

1 glass melting furnace

2 melt tank

3 glass melt

4 glass level

5 supply hopper

6 doghouse

6a doghouse cover

6b doghouse side walls

7 furnace wall

8 doghouse opening

9 device frame

10 wheels

11 rails

12 supports

13 frame

14 frame

15 arm

18 sealing plate

19 spacer mount

20 heat protection shield

21 transport device

22 transport device

23 shaft

23a geared motor

23b helical coil

24 shaft

24a geared motor

24b helical coil

25 housing

25a opening

26 housing

26a opening

27 pass-through opening

28 pusher arm

29 insert

30 slot

31 intermediate piece

32 platform

33 arm

34 arm

35 eccentric drive

36 intermediate joints

37 intermediate joints

38 pusher

39 circumferential path

40 distributor chamber

40a limb

40b limb

41 intermediate piece

42 intermediate piece

1-21. (canceled)

22. A method for supplying glass melting furnaces having at least one doghouse with free-flowing glass mixtures, comprising the steps:
introducing the glass mixtures through a doghouse opening above a glass level of a glass melt in the glass melting furnace with transport devices,
periodically driving a pusher with a pusher arm to distribute the glass mixture on the glass melt,
guiding the transport devices and the pusher arm through the doghouse opening in a manner so that the doghouse opening is at least extensively sealed,
supplying the glass mixtures to the transport devices from a common supply container via a distributor chamber,
applying the glass mixtures onto the glass melt using two transport devices situated next to one another that are controllable independently of one another with regard to the conveyed quantities per time unit, and
distributing and displacing the glass mixtures on the glass melt through continuous rotational movements of the pusher on both sides of the pusher arm.

23. The method as recited in claim 22, wherein the transport devices deposit portions of glass mixture divided from one another in a pair of rows on the glass melt.

24. The method as recited in claim 22, wherein the inner cross-sections of the transport devices are kept at least extensively sealed against the interior chamber of the doghouse.

25. The method as recited in claim 22, wherein the transport devices comprise screw conveyors having helical coils carried on shafts and tubular housings that are situated in pairs and at least extensively sealed in a sealing plate of the doghouse opening.

26. The method as recited in claim 25, wherein the shafts of the transport devices are each oriented at an acute angle to the direction of advance of the pusher.

27. The method as recited in claim 23, wherein transport directions of the rows of portions of glass mixture on the glass melt are modifiable by modifying angular positions of the pusher relative to its direction of advance.

28. The method as recited in claim 27, wherein the transport directions of the portions of the glass mixture on the glass melt are modifiable by modifying the angular positions of partial surfaces of the pusher relative to its direction of advance.

29. A device for supplying glass melting furnaces having a doghouse with free-flowing glass mixtures, comprising:
transport devices arranged to introduce the glass mixture through a doghouse opening of the glass melting furnace above a glass level of a glass melt in the glass melting furnace,
a pusher that is driven via a pusher arm for distributing the glass mixture on the glass level,
the transport devices and the pusher arm being introduced through the doghouse opening of the glass melting furnace in a manner at least extensively sealed,
the transport devices being connected via a distributor chamber to a common supply container for the glass mixture,
for the glass mixture, two transport devices are situated next to one another in the doghouse that can be controlled independently of one another with regard to the conveyed quantities per time unit, and
the transport devices are situated on both sides of a vertical virtual midplane in which the pusher arm of the pusher is movable.

30. The device as recited in claim 29, wherein the transport devices deposit portions of glass mixtures separated from one another in pairs on the glass level.

31. The device as recited in claim 30, wherein the inner cross-sections of the transport devices are at least extensively sealed against an interior chamber of the doghouse.

32. The device as recited in claim 29, wherein the transport devices are fashioned as screw conveyors having helical coils and tubular housings that are situated in pairs and at least extensively sealed in a sealing plate of the doghouse opening.

33. The device as recited in claim 32, wherein situated in front of the sealing plate is a heat protection shield whose circumference is large enough to be laid against an outer edge of the doghouse opening.

34. The device as recited in claim 29, wherein the axes of the transport devices are each oriented at an acute angle relative to the virtual vertical midplane.

35. The device as recited in claim 29, wherein the angular position of the pusher to its pusher arm is modifiable.

36. The device as recited in claim 35, wherein the pusher has partial surfaces having varying angular positions relative to its pusher arm.

37. The device as recited in at least one of claim 33, wherein the transport devices, the sealing plate, and the heat protection shield are fastened to a device frame that is movable in the direction toward the doghouse in a manner such that the heat protection shield at least extensively seals the doghouse opening.

38. The device as recited in claim 37, wherein the device frame has two horizontal frames connected to one another at their corners by vertical supports.

39. The device as recited in claim 38, wherein in a space between the supports there is situated a platform to which the pusher arm is connected and that is connected on one side by a rigidly attached arm to an eccentric drive through which the pusher receives a circumferential path.

40. The device as recited in claim 39, wherein an opposite side of the platform is supported on the device frame via vertically spaced intermediate joints having horizontal axes in such a way that movements of the platform having horizontal components can be compensated.

41. The device as recited in claim 37, wherein on the device frame, above a distributor chamber there is situated a supply hopper for the glass mixture having two limbs connected to the transport devices via funnel-shaped intermediate pieces.

42. The device as recited in claim 37, wherein a pass-through opening for the pusher arm is situated in the sealing plate, and the pass-through opening has an elastomeric insert having a vertical slot in which the pusher arm is guided so as to be sealed.
